(19) United States
(12) Patent Application Publication
(10) Pub. No.: US 2026/0166648 A1
(43) Pub. Date: Jun. 18, 2026

(54) SYSTEMS AND METHODS FOR HIGH-THROUGHPUT, ARBITRARY 3D LASER PROCESSING USING A METALENS ARRAY

(71) Applicant: Lawrence Livermore National Security, LLC, Livermore, CA (US)

(72) Inventors: Songyun GU, Dublin, CA (US); Sarvesh Abhishek SADANA, Fremont, CA (US); Xiaoxing XIA, Pleasanton, CA (US)

(73) Assignee: Lawrence Livermore National Security, LLC, Livermore, CA (US)

(21) Appl. No.: 19/365,879

(22) Filed: Oct. 22, 2025

Related U.S. Application Data
(60) Provisional application No. 63/735,476, filed on Dec. 18, 2024.

(51) Int. Cl. B23K 26/06; B23K 26/342; B23K 26/38; B29C 64/268; B33Y 10/00; B33Y 30/00

(52) U.S. Cl. CPC B23K 26/0648; B23K 26/342; B23K 26/38; B29C 64/268; B33Y 10/00; B33Y 30/00

(57) ABSTRACT

The present disclosure relates to a system for performing laser processing. In one embodiment the system has an electronic control system and a laser processing subsystem. The laser processing subsystem has at least one laser for generating a laser beam and at least one spatial light modulator (SLM). The SLM has a plurality of pixels and generates a patterned light beam, using the laser beam, to carry out a manufacturing or material processing operation. A non-imaging metalens array is used which has a plurality of independent metalens units, each one or more being uniquely associated with one or more pixels of the SLM. The metalens array creates focal light points in accordance with the patterned light beam to at least one of manufacture a part in an additive or subtractive manufacturing process, an 3D printing process or a process or act on a material.

### CROSS-REFERENCE TO RELATED APPLICATIONS

This application claims the benefit of U.S. Provisional Application No. 63/735,476, filed on Dec. 18, 2024. The entire disclosure of the above application is incorporated herein by reference.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to systems and methods for laser processing, and more particularly to systems and methods which enable parallel laser processing using a metalens array, and which is able to control greyscale intensity, and in some implementations to fabricate wafer-scale arbitrary 3D micro/nano-structures using an AM printing process.

### BACKGROUND

The statements in this section merely provide background information related to the present disclosure and may not constitute prior art.

In the last decade, many parallel laser exposure techniques have been developed, including using holography to generate the exposure geometry, scanning multiple focal spots, and directly projecting of a 2D pattern. Despite great efforts, these methods all face challenges with current state-of-the-art laser modulation devices and laser focusing devices. For example, although a focal spot array can be generated via binary holography using a digital micrometer device (i.e., “DMD”), such systems are limited by the low power efficiency due to the modulation principle of such holographic techniques. On the other hand, such systems are reaching the digital micromirror device's maximum modulation capacity, i.e., limited pixel numbers and bit depth for each pixel, that limits their future scale-up. There are also other systems pursuing higher efficiency through custom diffractive optical elements. Yet, the focal spots generated by these systems are not tunable, making them unsuitable to fabricate arbitrary 3D structures.

Accordingly, there is a continuing need in the industry for new laser processing capability which enable a high-throughput production of tailored architected metamaterials, complex MEMS devices, and on-demand semiconductor packaging solutions.

### SUMMARY

This section provides a general summary of the disclosure, and is not a comprehensive disclosure of its full scope or all of its features.

In one aspect the present disclosure relates to a system for performing laser processing. The system may comprise an electronic control system and a laser processing subsystem. The laser processing subsystem may have at least one laser for generating a laser beam and at least one spatial light modulator. The spatial light modulator has a plurality of pixels and is responsive to the electronic control system for generating a patterned light beam using the laser beam, needed to carry out a manufacturing or material processing operation. The system may also include a non-imaging, metalens array comprised of a plurality of independent lens units, each being uniquely associated with one or more pixels of the spatial light modulator. The metalens array is configured to create focal light points in accordance with the patterned light beam generated by the spatial light modulator to at least one of manufacture a part in an additive or subtractive manufacturing process, an 3D printing process or a process or act on a material.

In another aspect of the present disclosure the lens metalens array comprises a metalens array having a plurality of adjacently positioned metalens units in an X/Y grid pattern.

In another aspect of the present disclosure each said metalens unit creates a single one of the focal light points.

In another aspect of the present disclosure the metalens units are configured in at least one of a square, rectangular or circular shape.

In another aspect of the present disclosure the laser processing subsystem includes the at least one laser, a quarter wave plate, a polarization beam splitter disposed between the one or more lasers and the quarter wave plate for passing a portion of the laser beam from the laser to the quarter wave plate, and a spatial light modulator for receiving the laser beam downstream from the quarter wave plate and creating the patterned light beam.

In another aspect of the present disclosure the patterned light beam comprises a flat top beam profile.

In another aspect of the present disclosure the system further comprises a 4-f telescope including a first lens, a second lens spaced apart from the first lens, and a vacuum cell interposed between the first and second lens. The first lens, the vacuum cell and the second lens are configured to receive the patterned light beam and to pass the patterned light beam therethrough to the metalens array while ensuring that no ionization of air occurs.

In another aspect of the present disclosure the system further comprises a mirror disposed downstream of the 4-f telescope for reflecting the patterned light beam received from the 4-f telescope towards the metalens array.

In another aspect of the present disclosure the system is configured to selectively photopolymerize portions of a photo-resin feedstock material to form a three dimensional part in a layer-by-layer operation.

In another aspect of the present disclosure the system further comprises a build stage disposed adjacent the metalens array upon which the three dimensional part is built.

In another aspect the present disclosure relates to a system for performing selective laser photopolymerization of a photo-resin feedstock material to manufacture a three dimensional part in a layer-by-layer process. The system may comprise an electronic control system, a build stage, and a laser processing subsystem. The laser processing subsystem may have at least one laser for generating a laser beam and a spatial light modulator. The spatial light modulator may have a plurality of pixels which are responsive to the electronic control system for generating a patterned light beam using the laser beam. The patterned light beam can be used to selectively photopolymerize portions of the photo-resin to carry out manufacturing the three dimensional part. The system may also include a non-imaging metalens array disposed adjacent the build stage. The metalens array may have a plurality of independent metalens units, with each being uniquely associated with one or more pixels of the spatial light modulator. The metalens array is configured to create a plurality of focal light points in accordance with the patterned light beam generated by the spatial light modulator. The plurality of focal light points are used to selectively photopolymerize portions of the photo-resin feedstock to manufacture the three dimensional part on the build stage.

In another aspect of the present disclosure each metalens unit creates a single one of the focal light points.

In another aspect of the present disclosure the laser processing subsystem includes the at least one laser, a quarter wave plate and a polarization beam splitter disposed between the laser and the quarter wave plate for passing a portion of the laser beam from the laser to the quarter wave plate. The spatial light modulator receives the laser beam downstream from the quarter wave plate and creates the patterned light beam.

In another aspect of the present disclosure the system further comprises a 4-f telescope including a first lens, a second lens spaced apart from the first lens, and a vacuum cell interposed between the first and second lens. The first lens, the vacuum cell and the second lens are configured to receive the patterned light beam and to pass the patterned light beam therethrough to the metalens array while ensuring that no ionization of air occurs.

In another aspect the present disclosure relates to a method for performing laser processing. The method may comprise generating a laser beam using a laser processing, and using a spatial light modulator having a plurality of independently controllable pixels to receive the laser beam. The method may further include using the spatial light modulator to generate a pattern needed to pattern the laser beam to create a patterned light beam for carrying out a manufacturing or material processing operation. The method may involve using a non-imaging metalens array having of a plurality of independent lens units, with each one of the metalens units being uniquely associated with one or more pixels of the metalens array, to receive the patterned light beam. The metalens array is used to create a plurality of focal light points in accordance with the pattern generated by the spatial light modulator to at least one of manufacture a part in an AM printing process or process or act on a material.

In another aspect of the present disclosure the method involves using a 4-f telescope to receive and pass the patterned light beam to the metalens array. The 4-f telescope prevents ionization of air by the patterned light beam.

In another aspect of the present disclosure the AM printing process is performed using a photo-resin which is selectively photopolymerized by the patterned laser beam to form a three dimensional part on a build stage.

In another aspect of the present disclosure an electronic control system is used to control at least one of the laser or the spatial light modulator.

In another aspect the present disclosure the operation of using a metalens array comprises using a metalens array having a plurality of metalenses disposed adjacent one another in an X/Y grid pattern. Each one of the metalenses generates an associated one of the plurality of focal light points.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a high level block diagram of one embodiment of a system in accordance with the present disclosure for performing high throughput, arbitrary 3D laser processing using a metalens array;

FIG. 2 is a high level block diagram of the laser processing system shown in FIG. 1 along with the metalens array of FIG. 1, and also a build stage on which the 3D part is being built;

FIG. 3a is a series of illustrations representing how a 1×2 metalens array is actively modulated to print two different structures by controlling the print path by sectioning each metalens'target pattern into overlapping and non-overlapping regions;

FIG. 3b shows the printed adjacent regions in a single diagram;

FIG. 4a is a Scanning Electron Microscope (SEM) illustration of a plurality of numbers that were printed using the systems and methods of the present disclosure, and where each number was printed using a 200 μm×200 μm metalens;

FIG. 4b is a SEM image of a Pirc Defense chess opening printed via two-photon lithography, where each piece of the chess was printed by a 200 μm×200 μm metalens, and where the scale bar is 500 μm; and

FIG. 5 is a high level flowchart of operations that may be performed in uniquely associating each metalens element of a metalens array with a specific sub-part of a part to be produced, and using a slicing algorithm to determine the needed SLM patterns and print trajectories, where all the sub-parts are super positioned in the algorithm to find their overlapping volumes.

### DETAILED DESCRIPTION

Example embodiments will now be described more fully with reference to the accompanying drawings.

The present disclosure relates to new systems and methods relating to a novel laser processing strategy to rapidly fabricate wafer-scale, arbitrary, 3D micro-/nanostructures using a metalens array. Existing parallel laser processing methods, such as scanning multiple focal spots generated by diffractive optical elements (DOE), have heretofore lacked the controllability for each individual focal spot, thus limiting them to fabricating periodic structures only. To address this issue while maintaining the advantage of parallel laser processing, the present disclosure makes use of a laser system that employs spatial light modulator(s) (SLM) in conjugation with a metalens array to control the grayscale intensity and the on/off states for the focal spot generated by each metalens. The present disclosure further presents an algorithm which is able to (1) segment arbitrary 3D structures into sub-structures, (2) assign each sub-structure to each metalens, and (3) find unique SLM phase patterns and the corresponding processing regions. These features of the systems and methods disclosed herein unlock the capabilities to fabricate, for instance, custom metamaterial structures for mechanics and photonics, complex MEMS devices, and on-demand 3D chip packaging solutions.

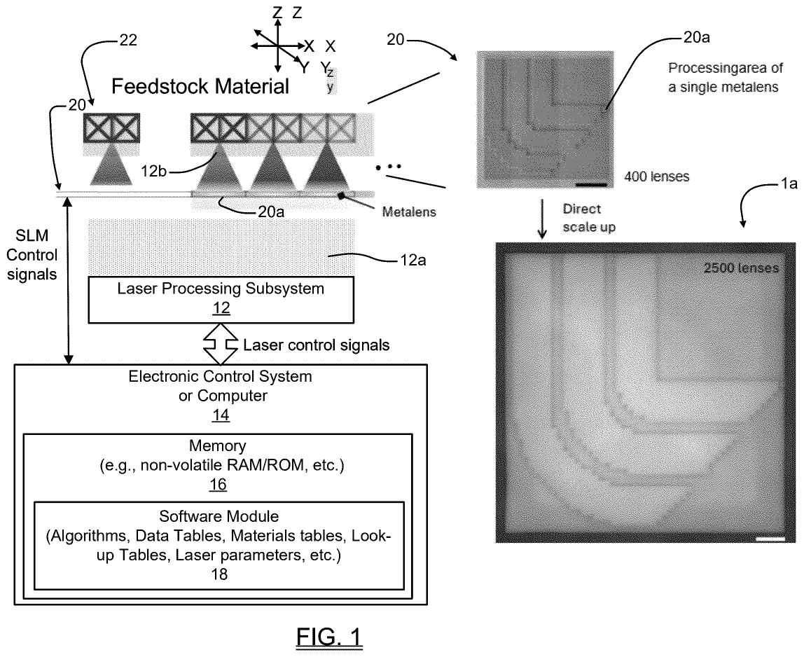

FIG. 1 is a simplified, high level block diagram illustration of a laser processing system 10 in accordance with one embodiment of the present disclosure. In one specific implementation the laser processing system 10 is used to carry out a two-photon lithography process to make a 3D part, although as will be apparent from the following paragraphs, the system 10 is expected to find utility in a wide variety of laser processing applications besides two-photon lithography. In this specific example the system 10 incorporates a laser processing subsystem 12 and an electronic control system or computer 14 (hereinafter simply “ECS”) which may be used to control the laser processing subsystem 12 in whole or in part. The ECS 14 may include a memory 16, for example a non-volatile memory (RAM/ROM/DRAM, etc.) for storing one or more software modules 18. The software module 18 may be used to store any information useful or needed for making parts with a two photon lithography manufacturing process. Such information may include, without limitation, one or more algorithms, data tables, materials tables, look-up tables, laser parameters, etc. The laser processing subsystem 12 generates a patterned light beam 12a which is directed at a non-imaging metalens array 20. The metalens array 20 may be an array of adjacent metalens units or cells 20a configured most typically in a planar rectangular or square X/Y grid. Alternatively, the metalens array 20 may be configured with a different shape (e.g., generally circular), and the individual metalenses can be arranged in a square grid, hexagonal pattern or other periodic or non-periodic arrangements. The present disclosure is not limited to any particular overall shape or arrangement of the metalens array 20.

The metalens array 20 creates a plurality of parallel generated beam focal spots 12b which are directed into a photo-resin feedstock material 22 in contact with a build stage or build plate. This process initiates the photopolymerization of select portions of the photo-resin feedstock material needed to construct the 3D part. This can be achieved by scanning the build stage 38, the metalens array 20, the patterned light beam 12a, or any arbitrary combination of these methods. In this regard it will be appreciated that the photo-resin feedstock material 22 is a quantity of photo-resin which is susceptible to polymerization when exposed to a specific wavelength (or wavelength range) and intensity of light.

It will also be appreciated that the metalens array 20 is a non-imaging component, in contrast to a conventional objective lens, which actually obtains or passes an image. Those skilled in the art will appreciate that an imaging operation is not possible with the metalens array 20 described herein; rather, the metalens array 20 simply focuses received light into a plurality of focused points of light.

Referring further to FIG. 1, some of the metalens focal spots 12b of the patterned beam 12a can be selectively turned off, while others can be tuned in grayscale (i.e., adjusted in intensity) for different processing needs, as will be discussed further in the following paragraphs. The inset illustration shows a plan view of the metal lens array 20 incorporating 400 independent metalenses, with a specific one of the metalenses called out with reference number 20a. Direct scaling is easily accomplished, and the inset illustration illustrates the metalens array 20 upscaled to include 2500 independent metalenses arranged in a generally square configuration.

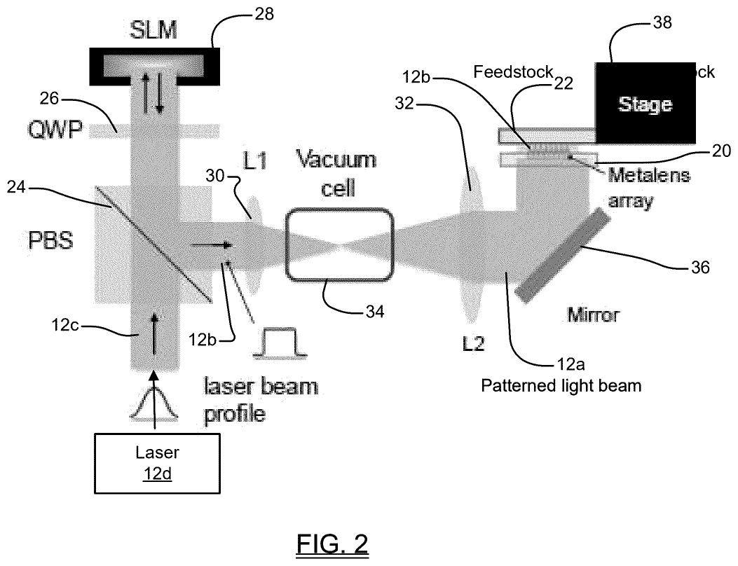

Referring to FIG. 2, the laser processing subsystem 12 is shown in greater detail. The laser processing subsystem 12 in some embodiments incorporates a polarization beam splitter (“PBS”) 24 for receiving a laser beam 12c from a laser 12d of the laser processing subsystem 12, a quarter wave plate (“QWP”) 26 for introducing a 45 degree phase shift to the polarized light being received and passed through, and a light modulation control component 28, which in this embodiment is a spatial light modulator (“SLM”). The SLM 28 is positioned in conjugation with the metalens array 20 to pattern the laser beam to create the focal spots 12b, as illustrated in FIGS. 1 and 2. Lenses 30 and 32 are provided, along with a vacuum cell 34, which essentially forms a 4-f system to project the pattern defined by the SLM 28 to the metalens array 20. The vacuum cell 34 ensures that no ionization of air occurs due to the extremely high power of the beam at the intermediate focal spot. Alternatively, such a system to project a patterned laser beam to the metalens array 20 may be configured with different optical setups or devices, (e.g., with a digital micro-mirror device), and the present disclosure is not limited to any particular optical configuration(s).

With further reference to FIG. 2, a mirror 36 redirects the patterned light beam 12a toward the metalens array 20, which then generates the focal spots 12b into the photo-resin feedstock material 22. The photo-resin feedstock material 22 is in contact with a build plate or build stage 38, on which the 3D part is being constructed by scanning the build stage 38 together with controlling the focal spots 12b.

One principle and method which may be used for beam shaping is described in U.S. Patent Application Ser. No. 63/735,564, filed on Dec. 18, 2024 and hereby incorporated by reference into the present application, which is entitled “Systems and Methods For Scalable 3D Laser Processing Using a Metalens Array”, and which is assigned to the assignee of the present disclosure. To write uniform structures, the focal spots 12b produced by the SLM 28 may be calibrated into a uniform array of focal spots 12b by tuning the SLM 28 phase pattern. On top of that, the focal spots 12b can be further independently tuned in grayscale, as well as turned on/off, to meet the needs for different laser processing conditions. In some applications the SLM 28 is controlled by control signals from the ECS 14. In some embodiments the SLM 28 may have its own controller which determines how each metalens of the metalens array 28 needs to be controlled.

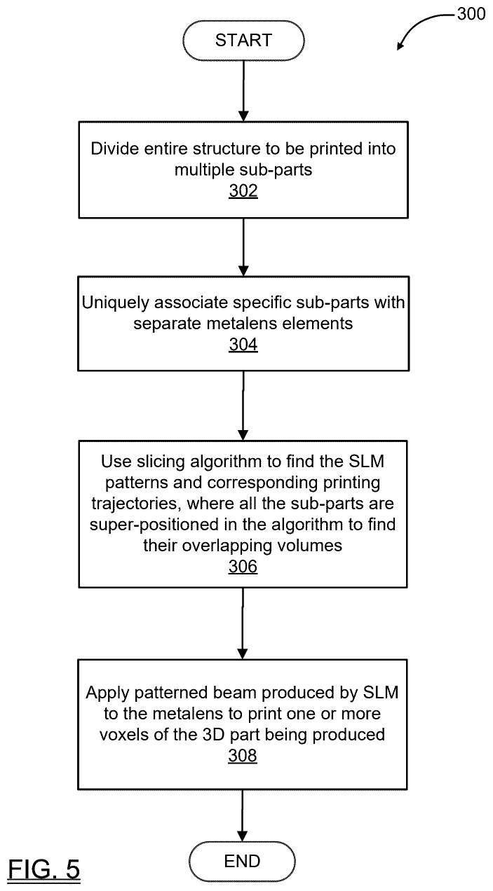

With this capability of controlling the individual focal spots 12b, arbitrary 3D structures can be created by scanning the sample stage 38 in combination with the SLM 28 pattern switching. This will be explained with brief reference to the flowchart 300 of FIG. 5. First, the entire 3D structure to be constructed may be divided into multiple sub-parts, as indicated at operation 302. Each sub-part may then be uniquely assigned to a separate metalens 20a element, as indicated at operation 304. The lateral size of each sub-part is equal to the pitch of each metalens 20a of the metalens array 20. Next, at operation 306, a slicing algorithm may be applied to find the SLM 28 patterns and corresponding printing trajectories, where all the sub-parts are super-positioned in the algorithm to find their overlapping volumes. This information, which is now represented in the patterned light beam 12a may then be applied to the metalens 20 which selectively illuminates voxels within the photo-resin feedstock 22 to build the part using a two-photon lithography process, as indicated at operation 308.

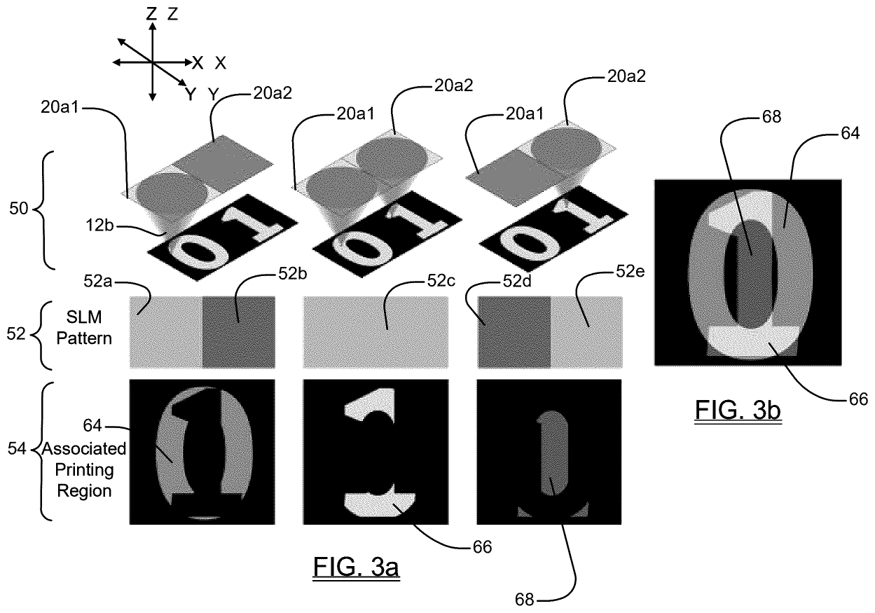

FIG. 3a illustrates how the algorithm works in a relatively simple condition, where there are only two metalenses 20a1 and 20a2 in a 1×2 metalens array 20, and the two metalens units in the 1×2 metalens array are being used to write a “0” and “1” 2D structure, respectively. The top row 50 is an illustration of the writing process, wherein the “0” represents one focal spot associated with metalens 20a1, and the “0” represents one focal spot associated with metalens 20a2. The middle row 52 shows the corresponding SLM pattern with 52a indicating metalens 20a1 receiving an optical signal and 52 indicating the metalens 20a2 not receiving any optical signal. Reference number 52c represents both metalenses 20a1 and 20a2 receiving optical signals. Reference number 52d represents metalens 20a1 not receiving any optical signal, and reference number 52e represents metalens 20a2 receiving an optical signal.

In FIG. 3a the bottom row 54 shows the associated printing region (i.e., enlarged for explanation purposes). Thus, each image in row 54 corresponds to the area of one metalens of the metalens array 20. To print the two sub-parts “0” and “1”, their patterns are first overlayed to find the overlapping areas and the non-overlapping areas, as also color coded in FIG. 3a. Reference number 64 indicates the non-overlapping area. The overlapped areas would be printed with both focal spots on (i.e., the light beam focal spot produced from each of metalens 20a1 and 20a2 on), while the non-overlapping area 64 would be printed only with its corresponding focal spot. Specifically, the green region 64 in FIG. 3b means only the focal spot for “0” is on; the yellow region 66 means both focal spots are on; and the blue region 68 means only the focal spots for “1” is on. After running the structure through the algorithm, one will obtain a series of unique SLM phase patterns, i.e., a series of unique focal spot combinations, and their corresponding printing regions, needed to print a given layer of a 3D part. The combined printing region of the structure is shown in FIG. 3b.

Such path planning algorithm and laser processing implementation can be carried out with an arbitrarily large number of metalenses including, but not limited to, 1 million metalenses. The overall throughput of the system 10 is defined by the overlayed structure when executing the algorithm. It is worth noting that regardless of the complexity of the desired part, the upper bound on print time is simply the time to print a solid block with the lateral size equal to the metalens pitch, which is also the limit for most other parallel techniques, such as projection-based two photon lithography. For ordered 3D structures with low filling ratio, such as electronic circuits and lattice structures, this strategy can greatly improve the printing throughput based on the volume filling ratio of the structure. The overall process for generating a laser processing toolpath for adaptive parallel processing, as illustrated in FIG. 3a may thus be summarized by the following operations:
1) initially defining a working volume for a single, non-imaging metalens to be used in the adaptive parallel processing to form an arbitrary 3D structure;
2) segmenting the arbitrary 3D structure into a plurality of sub-structures;
3) determining overlapping and non-overlapping regions when the sub-structures are super-positioned into the single metalens working volume;

4) generating a series of laser processing toolpaths that are associated with a series of focal spot array configurations, the series of laser processing toolpaths forming an entirety of the arbitrary 3D structure after being executed at least one of sequentially or non-sequentially.

It will also be appreciated that the metalens array 44 is a non-imaging component, in contrast to a conventional objective lens, which actually obtains or passes an image. Those skilled in the art will appreciate that an imaging operation is not possible with the metalens array 44 described herein; rather, the metalens array 44 simply focuses received light into a plurality of focused points of light.

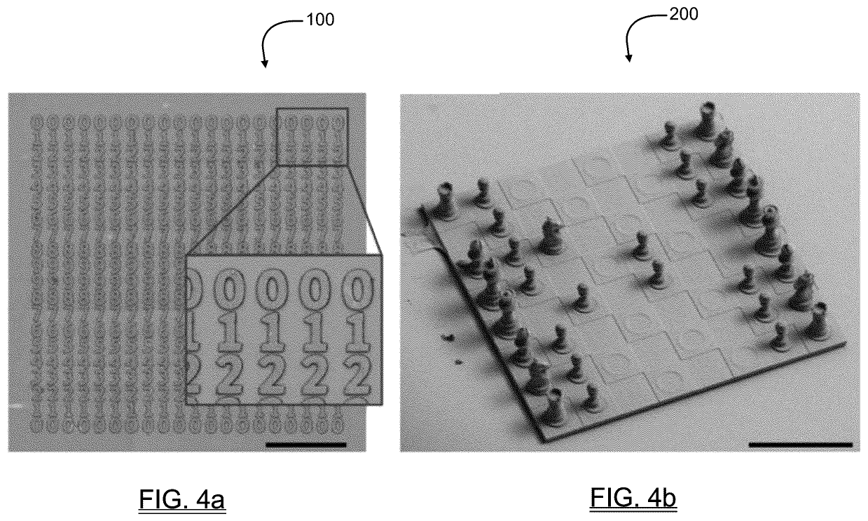

FIGS. 4a and 4b shows the laser processing result via two-photon lithography. FIG. 4a is a SEM image 100 of a set of numbers from 0-9 printed via two-photon lithography. In this example each number was printed using a 200 μm×200 μm metalens, such as metalens 20 described herein. The scale bar in FIG. 4b is 1 mm. FIG. 4b is a SEM image 200 of a “Pirc Defense” chess opening printed using the teachings of the present disclosure, where the algorithm is applied to each layer of the chess structure. These results prove the function of the algorithm to segment and control the system to print large-scale, arbitrary 3D structures, and can be easily extended to wafer-scale by using an even larger metalens array.

It will also be appreciated that while the above description has focused on the use of a metalens array, other forms of focusing could be substituted for a metalens array. For example, a different form of focusing component such as a microlens array could be instead. The microlens array could also be constructed larger to print larger feature structures.

It will also be appreciated that while the foregoing discussion has largely focused on applying the laser processing features of the present disclosure with a two photon lithography printing process, that the laser processing teachings described herein may be used in a wide variety of other applications as well. For example, the laser processing systems and methods described herein may also be applied in laser machining (ablation, engraving, patterning, cutting, selective laser etching, laser-induced materials property change, such as writing waveguides), laser-driven direct metal printing, and laser-enabled data storage. The processes that the laser processing teachings described herein can be used in may be any one or more of additive, subtractive, or even property-altering.

The laser processing methods and systems described herein can also be used for both 2D and 3D patterns. For 3D patterns, laser processing may be in a layer-by-layer fashion (e.g., stacking 2D processes one layer after another, while moving in direction in z). Or, segmentation for each metalens can also be done in 3D. Still further, a subset of the metalenses can be turned on to print 3D features in parallel, and then another subset is turned on to print complementary 3D features, so on and so forth. In such a process, the printing system will move up and down along the z axis in order to connect individual 3D segments.

In some implementations, the teachings of the present disclosure may be used to carry out a method for generating a laser processing toolpath for adaptive parallel processing. In this implementation, initially one will define a working volume for a single metalens 20a to be used in the adaptive parallel processing to form an arbitrary 3D structure. Next, the arbitrary 3D structure may be segmented into a plurality of sub-structures. Next, overlapping and non-overlapping regions can be determined when the sub-structures are super-positioned into a working volume of a single metalens 20a. Next, a series of laser processing toolpaths may be generated that are associated with a series of focal spot array configurations produced by the SLM 28. The series of laser processing toolpaths forming an entirety of the arbitrary 3D structure after being executed at least one of sequentially or non-sequentially.

It will also be appreciated that in some implementations the system 10 may instead make use of, without limitation, an electron beam or an ion beam as the beam source instead of a laser beam. In such applications, a suitable focusing component, for example an electrostatic lens array, will be used instead of a SLM. Accordingly, the present disclosure is not limited to only use with a laser beam.

The systems and methods described herein can massively increase the laser processing throughput. In some applications the systems and methods described herein can be used to write wafer-scale arbitrary 3D structure with sub-micrometer resolution in an AM process. By providing large-scale fabrication capability for arbitrary 3D structures, the systems and methods described herein can be used to fabricate tailored architected meta-materials for on-demand mechanics and photonics applications. The systems and methods described herein can also be used to fabricate complex MEMS structures with higher structural designability and much reduced operation steps. It is anticipated that the systems and methods described herein will enable additive manufacturing to be applied in the semiconductor industry for the fabrication of 3D interconnects for chip stacking, high-performance liquid cooling micro-channels, and freeform waveguides for optical computing.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A system for performing laser processing, comprising:
an electronic control system;
a laser processing subsystem having:
at least one laser for generating a laser beam; and
at least one spatial light modulator having a plurality of pixels and being responsive to the electronic control system for generating a patterned light beam using the laser beam, needed to carry out a manufacturing or material processing operation;
a non-imaging metalens array comprised of a plurality of independent metalens units, each one or more of said independent metalens units being uniquely associated with one or more pixels of the spatial light modulator; and
the non-imaging metalens array configured to create focal light points in accordance with the patterned light beam generated by the spatial light modulator to at least one of manufacture a part in an additive or subtractive manufacturing process, an 3D printing process or a process or act on a material.

2. The system of claim 1, wherein the lens array comprises the plurality of adjacently positioned metalens units positioned in a grid.

3. The system of claim 2, wherein each said metalens unit creates a single one of the focal light points.

4. The system of claim 2, wherein the metalens units are configured in at least one of a square, rectangular or circular shape.

5. The system of claim 1, wherein the laser processing subsystem includes:
the at least one laser;
a quarter wave plate;
a polarization beam splitter disposed between the one or more lasers and the quarter wave plate for passing a portion of the laser beam from the laser to the quarter wave plate;
a spatial light modulator for receiving the laser beam downstream from the quarter wave plate and creating the patterned light beam.

6. The system of claim 5, wherein the patterned light beam comprises a flat top beam profile.

7. The system of claim 1, wherein the metalens array comprises the plurality of metalens units disposed adjacent to one another in an X/Y grid pattern.

8. The system of claim 1, wherein the system further comprises a 4-f telescope including:
a first lens;
a second lens spaced apart from the first lens;
a vacuum cell interposed between the first and second lens;
the first lens, the vacuum cell and the second lens being configured to receive the patterned light beam and to pass the patterned light beam therethrough to the metalens array while ensuring that no ionization of air occurs.

9. The system of claim 8, further comprising a mirror disposed downstream of the 4-f telescope for reflecting the patterned light beam received from the 4-f telescope towards the metalens array.

10. The system of claim 1, wherein the system is configured to selectively photopolymerize portions of a photo-resin feedstock material to form a three dimensional part in a layer-by-layer operation.

11. The system of claim 10, further comprising a build stage disposed adjacent the metalens array upon which the three dimensional part is built.

12. A system for performing selective laser photopolymerization of a photo-resin feedstock material to manufacture a three dimensional part in a layer-by-layer process, the system comprising:
an electronic control system;
a build stage;
a laser processing subsystem having:
at least one laser for generating a laser beam; and
a spatial light modulator having a plurality of pixels and being responsive to the electronic control system for generating a patterned light beam using the laser beam, the patterned light beam needed to selectively photopolymerize portions of the photo-resin to carry out manufacturing the three dimensional part;
a non-imaging metalens array disposed adjacent the build stage and comprised of a plurality of independent metalens units, each of said independent metalens units being uniquely associated with one or more pixels of the spatial light modulator; and
the metalens array configured to create a plurality of focal light points in accordance with the patterned light beam generated by the spatial light modulator to selectively photopolymerize portions of the photo-resin feedstock to manufacture the three dimensional part on the build stage.

13. The system of claim 12, wherein each said metalens unit creates a single one of the focal light points.

14. The system of claim 12, wherein the laser processing subsystem includes
the at least one laser;
a quarter wave plate;
a polarization beam splitter disposed between the one or more lasers and the quarter wave plate for passing a portion of the laser beam from the laser to the quarter wave plate;
the spatial light modulator for receiving the laser beam downstream from the quarter wave plate and creating the patterned light beam.

15. The system of claim 14, wherein the system further comprises a 4-f telescope including:
a first lens;
a second lens spaced apart from the first lens;
a vacuum cell interposed between the first and second lens;
the first lens, the vacuum cell and the second lens being configured to receive the patterned light beam and to pass the patterned light beam therethrough to the metalens array while ensuring that no ionization of air occurs.

16. A method for performing laser processing, comprising:
generating a laser beam using a laser processing;
using a spatial light modulator having a plurality of independently controllable pixels to receive the laser beam;
using the spatial light modulator to generate a pattern needed to pattern the laser beam to create a patterned light beam for carrying out a manufacturing or material processing operation;
using a non-imaging metalens array having of a plurality of independent lens units, each one of said metalens units being uniquely associated with one or more pixels of the metalens array, to receive the patterned light beam; and
using the metalens array to create a plurality of focal light points in accordance with the pattern generated by the spatial light modulator to at least one of manufacture a part in an AM printing process or process or act on a material.

17. The method of claim 16, further comprising using a 4-f telescope to receive and pass the patterned light beam to the metalens array, the 4-f telescope preventing ionization of air by the patterned light beam.

18. The method of claim 16, wherein the AM printing process is performed using a photo-resin which is selectively photopolymerized by the patterned laser beam to form a three dimensional part on a build stage.

19. The method of claim 16, further comprising using an electronic control system to control at least one of the laser or the spatial light modulator.

20. The method of claim 16, wherein using a metalens array comprises using a metalens array having the plurality of metalens units disposed adjacent one another in an X/Y grid pattern, with each one of said metalens units generating an associated one of the plurality of focal light points.

21. A method for generating a laser processing toolpath for adaptive parallel processing, comprising:
defining a working volume for a single, non-imaging metalens to be used in the adaptive parallel processing to form an arbitrary 3D structure;
segmenting the arbitrary 3D structure into a plurality of sub-structures;
determining overlapping and non-overlapping regions when the sub-structures are super-positioned into the single, non-imaging metalens working volume;
generating a series of laser processing toolpaths that are associated with a series of focal spot array configurations, the series of laser processing toolpaths forming an entirety of the arbitrary 3D structure after being executed at least one of sequentially or non-sequentially.
